(19) United States
(12) Patent Application Publication
(10) Pub. No.: US 2026/0101337 A1
(43) Pub. Date: Apr. 9, 2026

(54) SCHEDULING AND SEARCH SPACES FOR LOW DUTY CYCLE NON-TERRESTRIAL NETWORKS

(71) Applicant: QUALCOMM Incorporated, San Diego, CA (US)

(72) Inventors: Ayan SENGUPTA, San Diego, CA (US); Alberto RICO ALVARINO, San Diego, CA (US); Xiao Feng WANG, San Diego, CA (US)

(21) Appl. No.: 18/907,435

(22) Filed: Oct. 4, 2024

(51) Int. Cl. H04W 72/1273

(52) U.S. Cl. CPC H04W 72/1273

(57) ABSTRACT

Methods, systems, and devices for wireless communications are described. A user equipment (UE) may monitor for control signaling in one or more search spaces in accordance with a search space periodicity. The control signaling may schedule transmissions for the UE using a scheduling delay value. Generally, the described techniques enable the UE to receive an indication of a search space periodicity, scheduling delay value, or both that is aligned with a low duty-cycle communication interval. For example, the scheduling delay value, the search space periodicity, or both, may be shifted by integer multiples of the duty-cycle. Additionally, or alternatively, the scheduling delay value may be based on a quantity of valid communication frames.

### FIELD OF TECHNOLOGY

The following relates to wireless communications, including scheduling and search spaces for low duty cycle non-terrestrial networks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may communicate with a network entity via a non-terrestrial network in accordance with a communication interval.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving an indication of a scheduling delay value for one or more transmissions, where the scheduling delay value is based on the one or more transmissions being in accordance with one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the uplink communication sub-interval and a next uplink communication sub-interval of a next communication interval, and where at least one invalid subframe of the invalid sub-interval is between the downlink communication sub-interval and a next downlink communication sub-interval of the next communication interval and transmitting, or receiving, via one or more uplink communication subframes or one or more downlink communication subframes included in the one or more communication intervals, the one or more transmissions in accordance with the scheduling delay value.

A UE for wireless communications is described. The UE may include one or more memories storing processor executable code, a transceiver, and one or more processors coupled with the one or more memories and the transceiver. The one or more processors may individually or collectively be operable to execute the code to cause the UE to receive an indication of a scheduling delay value for one or more transmissions, where the scheduling delay value is based on the one or more transmissions being in accordance with one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the uplink communication sub-interval and a next uplink communication sub-interval of a next communication interval, and where at least one invalid subframe of the invalid sub-interval is between the downlink communication sub-interval and a next downlink communication sub-interval of the next communication interval and transmit, or receive, via the transceiver and one or more uplink communication subframes or one or more downlink communication subframes included in the one or more communication intervals, the one or more transmissions in accordance with the scheduling delay value.

Another UE for wireless communications is described. The UE may include means for receiving an indication of a scheduling delay value for one or more transmissions, where the scheduling delay value is based on the one or more transmissions being in accordance with one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the uplink communication sub-interval and a next uplink communication sub-interval of a next communication interval, and where at least one invalid subframe of the invalid sub-interval is between the downlink communication sub-interval and a next downlink communication sub-interval of the next communication interval and means for transmitting, or receiving, via one or more uplink communication subframes or one or more downlink communication subframes included in the one or more communication intervals, the one or more transmissions in accordance with the scheduling delay value.

A non-transitory computer-readable medium storing code for wireless communications is described. The code may include instructions executable by one or more processors to receive an indication of a scheduling delay value for one or more transmissions, where the scheduling delay value is based on the one or more transmissions being in accordance with one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the uplink communication sub-interval and a next uplink communication sub-interval of a next communication interval, and where at least one invalid subframe of the invalid sub-interval is between the downlink communication sub-interval and a next downlink communication sub-interval of the next communication interval, and transmit, or receive, via one or more uplink communication subframes or one or more downlink communication subframes included in the one or more communication intervals, the one or more transmissions in accordance with the scheduling delay value.

In some examples of the method, UEs, and non-transitory computer-readable medium described herein, transmitting, or receiving, the one or more transmissions in accordance with the scheduling delay value may include operations, features, means, or instructions for transmitting, or receiving, a first subset of the one or more transmissions in a first set of one or more uplink communication subframes or one or more downlink communication subframes included in a first communication interval included in the one or more communication intervals and transmitting, or receiving, in accordance with the scheduling delay value, a second subset of the one or more transmissions in a second set of one or more uplink communication subframes or one or more downlink communication subframes included in a second communication interval included in the one or more communication intervals.

In some examples of the method, UEs, and non-transitory computer-readable medium described herein, receiving the indication may include operations, features, means, or instructions for receiving downlink control information (DCI) indicating a quantity of communication intervals from among the one or more communication intervals, where the scheduling delay value may be based on the quantity of communication intervals from among the one or more communication intervals. In some examples of the method, UEs, and non-transitory computer-readable medium described herein, the DCI may be in accordance with a first format associated with the one or more communication intervals and indicates the quantity of communication intervals via a first portion of the DCI.

In some examples of the method, UEs, and non-transitory computer-readable medium described herein, the scheduling delay value may be based on at least one of: a quantity of communication intervals from among the one or more communication intervals or a duration of a communication interval from among the one or more communication intervals. In some examples of the method, UEs, and non-transitory computer-readable medium described herein, the scheduling delay value may be based on a quantity of one or more uplink communication subframes included in the one or more communication intervals, a quantity of one or more downlink communication subframes included in the one or more communication intervals, or both. In some examples of the method, UEs, and non-transitory computer-readable medium described herein, the scheduling delay value may be independent of a quantity of invalid subframes included in the one or more communication intervals.

In some examples of the method, UEs, and non-transitory computer-readable medium described herein, the one or more transmissions include one or more physical uplink shared channel (PUSCH) transmissions, one or more physical downlink shared channel (PDSCH) transmissions, one or more random access messages, one or more feedback response messages, or any combination thereof.

A method for wireless communications by a UE is described. The method may include monitoring a search space including a set of multiple control signal candidates in accordance with a periodicity, where the periodicity is based on one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the downlink communication sub-interval and a next downlink communication sub-interval of a next communication interval, and where at least one invalid subframe of the invalid sub-interval is between the uplink communication sub-interval and a next uplink communication sub-interval of a next communication interval and receiving one or more control signals associated with one or more control signal candidates of the set of multiple control signal candidates based on monitoring the search space in accordance with the periodicity.

A UE for wireless communications is described. The UE may include one or more memories storing processor executable code, a transceiver, and one or more processors coupled with the one or more memories and the transceiver. The one or more processors may individually or collectively be operable to execute the code to cause the UE to monitor a search space including a set of multiple control signal candidates in accordance with a periodicity, where the periodicity is based on one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the downlink communication sub-interval and a next downlink communication sub-interval of a next communication interval, and receive one or more control signals associated with one or more control signal candidates of the set of multiple control signal candidates based on monitoring the search space in accordance with the periodicity.

Another UE for wireless communications is described. The UE may include means for monitoring a search space including a set of multiple control signal candidates in accordance with a periodicity, where the periodicity is based on one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the downlink communication sub-interval and a next downlink communication sub-interval of a next communication interval, and means for receiving one or more control signals associated with one or more control signal candidates of the set of multiple control signal candidates based on monitoring the search space in accordance with the periodicity.

A non-transitory computer-readable medium storing code for wireless communications is described. The code may include instructions executable by one or more processors to monitor a search space including a set of multiple control signal candidates in accordance with a periodicity, where the periodicity is based on one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the downlink communication sub-interval and a next downlink communication sub-interval of a next communication interval, and receive one or more control signals associated with one or more control signal candidates of the set of multiple control signal candidates based on monitoring the search space in accordance with the periodicity.

Some examples of the method, UEs, and non-transitory computer-readable medium described herein may further include operations, features, means, or instructions for receiving an indication of the periodicity, where monitoring the search space in accordance with the periodicity may be based on the indication. In some examples of the method, UEs, and non-transitory computer-readable medium described herein, receiving the indication may include operations, features, means, or instructions for receiving radio resource control (RRC) signaling, system information signaling, or any combination thereof that includes the indication.

Some examples of the method, UEs, and non-transitory computer-readable medium described herein may further include operations, features, means, or instructions for dropping one or more second control signal candidates from among the set of multiple control signal candidates based on a time duration between the one or more second control signal candidates and a control signal candidate from a second search space different from the search space being less than a threshold duration.

In some examples of the method, UEs, and non-transitory computer-readable medium described herein, the periodicity may be based on at least one of: a quantity of communication intervals from among the one or more communication intervals or a duration of a communication interval from among the one or more communication intervals. In some examples of the method, UEs, and non-transitory computer-readable medium described herein, the periodicity may be based on a quantity of one or more uplink communication subframes included in the one or more communication intervals, a quantity of one or more downlink communication subframes included in the one or more communication intervals, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support scheduling and search spaces for low duty cycle non-terrestrial networks (NTNs) in accordance with one or more aspects of the present disclosure.

FIG. 3 shows an example of a signaling diagram that supports scheduling and search spaces for low duty cycle NTNs in accordance with one or more aspects of the present disclosure.

FIG. 4 shows an example of a process flow that supports scheduling and search spaces for low duty cycle NTNs in accordance with one or more aspects of the present disclosure.

FIGS. 5 and 6 show block diagrams of devices that support scheduling and search spaces for low duty cycle NTNs in accordance with one or more aspects of the present disclosure.

FIG. 7 shows a block diagram of a communications manager that supports scheduling and search spaces for low duty cycle NTNs in accordance with one or more aspects of the present disclosure.

FIG. 8 shows a diagram of a system including a device that supports scheduling and search spaces for low duty cycle NTNs in accordance with one or more aspects of the present disclosure.

FIGS. 9 through 11 show flowcharts illustrating methods that support scheduling and search spaces for low duty cycle NTNs in accordance with one or more aspects of the present disclosure.

### DETAILED DESCRIPTION

In some wireless communications systems, a user equipment (UE) may communicate with a network entity in accordance with a low duty-cycle communications framework. For example, the UE and the network entity may communicate during communication intervals that each include one or more uplink frames, one or more downlink frames, and at least one invalid frame (e.g., invalid for communications) between the one or more uplink frames and a next uplink frame in a next communication interval. In some examples, the network entity may transmit control signaling that includes a scheduling delay value. The scheduling delay value may indicate a quantity of subframes from receipt of the control signaling to transmission of one or more uplink transmissions or a quantity of subframes from receipt of the control signaling to reception of one or more downlink transmissions. In some examples, the UE may monitor, via one or more search spaces, for the control signaling during the communication interval in accordance with a search space periodicity. However, in other wireless communications systems, scheduling delay values and search space periodicities may not align with the low duty cycles of the communication intervals, resulting in collisions between scheduled transmissions (e.g., or receptions) and between search space candidates.

The techniques described herein enable a UE to receive an indication of a search space periodicity, a scheduling delay value, or both, that are aligned with the low duty-cycle communication interval. For example, the scheduling delay value, the search space periodicity, or both, may be shifted by integer multiples of the duty-cycle.

Additionally, or alternatively, the scheduling delay value may be based on a quantity of valid communication frames (e.g., opposed to valid and invalid frames in other wireless communication systems). In some examples, the UE may receive the indication of the aligned search space periodicity or scheduling delay value via control signaling. For example, the UE may receive an indication of the search space periodicity via radio resource control (RRC) configuration signaling, system information block (SIB) configuration signaling, or any combination thereof. The UE may receive an indication of the scheduling delay value via downlink control information (DCI) in the control signaling. For example, a bit field of the DCI may indicate a quantity of duty-cycle shifts or other bit fields (e.g., less relevant to low duty-cycle communication) may be repurposed to indicate the quantity of duty-cycle shifts. Aligning the search space periodicity and scheduling delay value with the low duty-cycle communication intervals may reduce search space candidate collisions as well as transmission scheduling collisions (e.g., in uplink or downlink).

Aspects of the disclosure are initially described in the context of wireless communications systems. Aspects of the disclosure are then illustrated by and described with reference to a signaling diagram and a process flow. Aspects of the disclosure are further illustrated by and described with reference to apparatus diagrams, system diagrams, and flowcharts that relate to scheduling and search spaces for low duty cycle non-terrestrial networks.

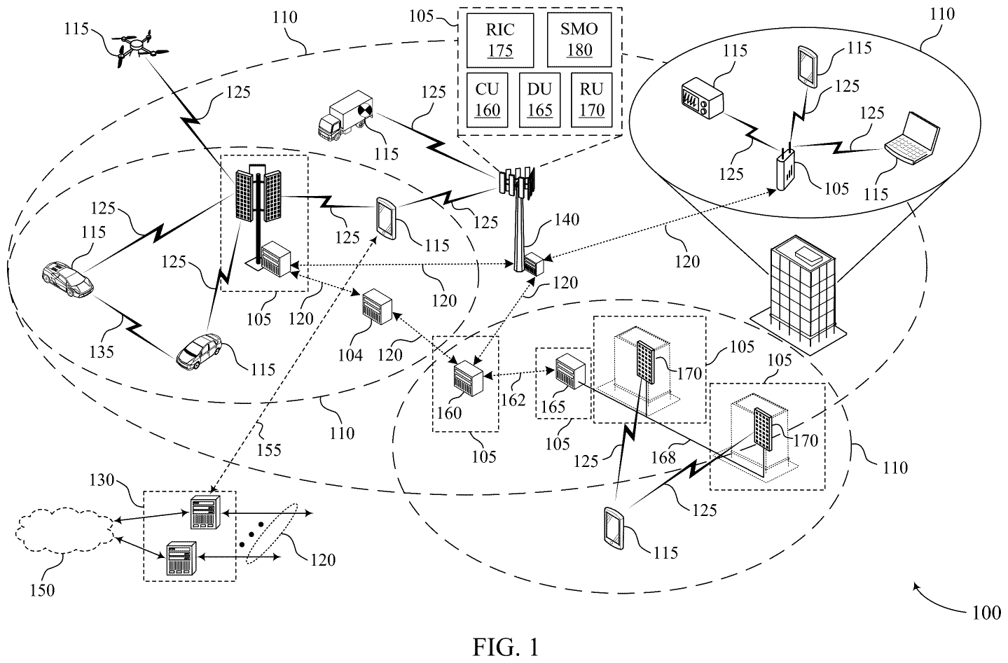

FIG. 1 shows an example of a wireless communications system 100 that supports scheduling and search spaces for low duty cycle non-terrestrial networks (NTNs) in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support scheduling and search spaces for low duty cycle NTNs as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, a UE 115 may communicate with a network entity 105 in accordance with a low duty-cycle communications framework. For example, the UE 115 and the network entity 105 may communicate during communication intervals that each include one or more uplink frames, one or more downlink frames, and at least one invalid frame (e.g., invalid for communications) between the uplink frame and a next uplink frame in a next communication interval. In some examples, the network entity 105 may transmit control signaling that includes a scheduling delay value. The scheduling delay value may indicate a quantity of subframes from receipt of the control signaling to transmission of one or more uplink transmissions or a quantity of subframes from receipt of the control signaling to reception of one or more downlink transmissions. In some examples, the UE 115 may monitor, via one or more search spaces, for the control signaling during the communication interval in accordance with a search space periodicity. However, in other wireless communications systems, scheduling delay values and search space periodicities may not align with the low duty cycles of the communication intervals, resulting in collisions between scheduled transmissions (e.g., or receptions) and between search space candidates.

The techniques described herein enable a UE 115 to receive an indication of a search space periodicity, a scheduling delay value, or both, that are aligned with the low duty-cycle communication interval. For example, the scheduling delay value, the search space periodicity, or both, may be shifted by integer multiples of the duty-cycle. Additionally, or alternatively, the scheduling delay value may be based on a quantity of valid communication frames (e.g., opposed to valid and invalid frames in other wireless communication systems). In some examples, the UE 115 may receive the indication of the aligned search space periodicity or scheduling delay value via control signaling. For example, the UE 115 may receive an indication of the search space periodicity via RRC configuration signaling, SIB configuration signaling, or any combination thereof. The UE 115 may receive an indication of the scheduling delay value via DCI in the control signaling. For example, a bit field of the DCI may indicate a quantity of duty-cycle shifts or other bit fields (e.g., less relevant to low duty-cycle communication) may be repurposed to indicate the quantity of duty-cycle shifts. Aligning the search space periodicity and scheduling delay value with the low duty-cycle communication intervals may reduce search space candidate collisions as well as transmission scheduling collisions (e.g., in uplink or downlink).

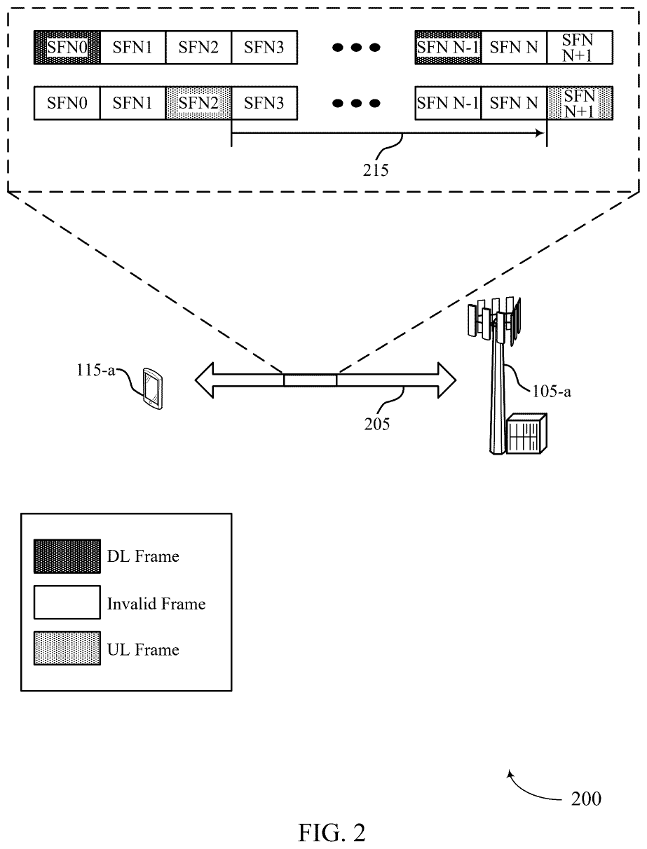

FIG. 2 shows an example of a wireless communications system 200 that supports scheduling and search spaces for low duty cycle NTNs in accordance with one or more aspects of the present disclosure. The wireless communications system 200 may implement or be implemented by aspects of the wireless communications system 100, as described with reference to FIG. 1. For example, the wireless communications system 100 includes a UE 115-a and a network entity 105-a, which may be examples of corresponding devices described herein, including with reference to FIG. 1. In some examples, the UE 115-a may receive one or more downlink transmissions, transmit one or more uplink transmissions, or both, via a communication link 205 (e.g., a communication link 125). For example, the UE 115-a may receive one or more downlink messages during one or more downlink (DL) frames and transmit one or more uplink messages during one or more uplink (UL) frames (e.g., system frames). Each frame may include one or more subframes or slots (e.g., ten subframes per frame). In some examples, the UE 115-a may not be allowed to transmit signaling during a respective DL frame or receive signaling during a respective UL frame. Additionally, or alternatively, the UE 115-a may not be allowed to receive or transmit signaling during invalid frames. As described herein, an invalid frame may be any frame in which the UE 115-a may not be allowed to perform communications (e.g., or expect to perform communications) via the communication link 205 (e.g., UL and/or DL). That is, an invalid subframe may be a subframe in which uplink transmission or downlink transmission may not take place.

In some examples, the UE 115-a and the network entity 105-a may communicate via a “low” duty-cycle communication interval (e.g., low duty-cycle TDD). For example, the UE 115-a may be a narrowband internet-of-things (NB-IoT) device, and may communicate using a low duty-cycle communication interval over NTNs (e.g., the network entity 105-a may be a satellite). As described herein, a low-duty cycle communication interval may be any communication interval where there is at least one invalid frame between one or more UL frames of a first communication interval (e.g., communication period) and a next UL frame of a next communication interval, at least one invalid frame between one or more DL frames of the first communication interval and a next DL frame of the next communication interval, and where the one or more UL frames and the one or more DL frames of each communication interval is non-overlapping in time. In some examples, the one or more UL frames may be referred to as an uplink communication sub-interval (e.g., a sub-interval of the communication interval that includes the one or more UL frames). Additionally, or alternatively, the one or more DL frames may be referred to as a downlink communication sub-interval (e.g., a sub-interval of the communication interval that includes the one or more DL frames). For example, a communication interval may include N frames (e.g., N system frames), where one or more of the N frames (e.g., SFN0) are DL frames that are non-overlapping with the one or more UL frames (e.g., SFN2). In one example low-duty cycle communication interval, one out ten frames (e.g., radio frames) may be used for uplink signaling and a different one out of ten frames may be used for downlink signaling.

In some examples, the UE 115-a may monitor one or more search spaces to receive control signaling via the communication link 205. For example, the search spaces may be physical downlink control channel (PDCCH) search spaces that include one or more PDCCH candidates (e.g., search space candidates). Search spaces may be known locations (e.g., determined at the UE 115-a) in time that the UE 115-a monitors in accordance with a search space periodicity to receive the control signaling. In some other wireless communications systems, a periodicity of the search spaces may be based on G×Rₘₐₓ(≥4), where G∈{1.5,2,4,8,16,32,48,64} ms.

In some examples, the UE 115-a may receive control signaling that schedules one or more transmissions (e.g., uplink or downlink) in one or more UL frames or in one or more DL frames via the communication link 205 (e.g., based on monitoring one or more search space candidates). For example, the UE 115-a may receive a PDCCH message that includes DCI, or the UE 115-a may receive a random access response (RAR) message that indicates a random access message (e.g., Msg3) for a random access procedure. The DCI (e.g., and/or the RAR message) may indicate the UE 115-a to transmit a physical uplink shared channel (PUSCH) message (e.g., and/or the Msg 3) at the end of a subframe n+k₀, where n is the last subframe in which the PDCCH message is transmitted and k₀ is a scheduling delay value 215. In some cases, the UE 115-a may determine n based on the starting subframe of the PDCCH transmission and a DCI subframe repetition number field in the DCI. Based on receiving the control signaling, the UE 115-a may transmit the one or more uplink transmissions in N consecutive UL slots (e.g., UL subframes) beginning at a subframe n₀. That is, k₀ may be a quantity of subframes between the subframe n and the first subframe of the one or more uplink transmissions, n₀. In some examples, n₀ may be the first uplink slot starting after the end of subframe n+k₀. In some cases, n₀ may further be based on a timing offset value (e.g., n₀=n+k₀+K_{offset}).

In some examples, invalid frames (e.g., invalid subframes or invalid slots) may result in postponement of a corresponding UL or DL message to a next valid frame. That is, the UE 115-a may receive a scheduling delay value 215 that schedules multiple uplink transmissions that span two or more UL frames. For example, the UE 115-a may receive scheduling for one or more PUSCH messages (e.g., narrowband PUSCH), random access procedure messages (e.g., Msg3), HARQ-ACK messages, or any combination thereof, during one or more UL frames and one or more invalid frames. Based on the low duty-cycle communication interval, the UE 115-a may transmit a first subset of the uplink transmissions during a first UL frame of a first communication interval and transmit (e.g., postpone) the remaining subset of uplink transmissions during a next UL frame of a next communication interval (e.g., because the frame after the first UL frame may be an invalid frame). That is, the UE 115-a may transmit the first subset during SFN2 and the second subset during SFN N+1 because SFN3 through SFN N may be invalid frames.

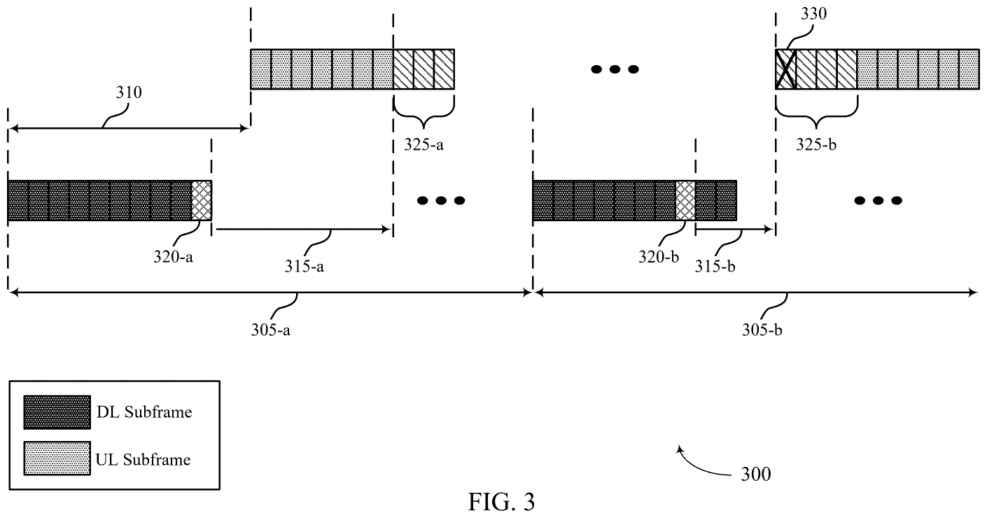

However, in some other wireless communications systems, values for scheduling delays may result in collisions between multiple scheduled transmissions based on communicating in accordance with the low-duty cycle communication interval. For example, a UE 115 in the other wireless communications systems may receive first control signaling indicating a first scheduling delay value in SFN0 and second control signaling indicating a second scheduling delay value in SFN N−1. As described further with reference to FIG. 3, the first scheduling delay value and the second scheduling delay value may schedule different uplink transmissions in the same UL frame or different downlink transmissions in the same DL frame based on the first and second scheduling delay values not aligning with the low duty cycle communication intervals. Additionally, in the other wireless communications systems, search space periodicities may not be aligned with the low-duty cycle communication interval. That is, search space periodicities in other communications systems may result in collisions between different search spaces. For example, after postponing one or more uplink transmissions based on the first scheduling delay value, one or more search spaces of the UE 115 may collide (e.g., resulting in the UE 115 dropping one or more conflicting PDCCH candidates or search spaces).

The techniques described herein enable the UE 115-a to receive an indication of scheduling delays and search space periodicities that are aligned with the low duty-cycle communication interval. For example, the UE 115-a may receive a scheduling delay value 215, a search space periodicity, or both, that is shifted by integer multiples of the low-duty cycle communication interval. In some examples, the UE 115-a may receive DCI indicating the scheduling delay value 215. In some cases, as described further with reference to FIG. 3, a bit field of the DCI may be increased to indicate the integer multiple shifts. In some other cases, other bit fields of the DCI may be repurposed to indicate the scheduling delay value 215 (e.g., using bit fields less relevant to low duty-cycle schemes). Additionally, or alternatively, the scheduling delay value 215 may align with the low duty-cycle communication interval based on counting valid frames (e.g., UL and/or DL frames), as opposed to counting valid and invalid frames in other communication systems. In some examples, the UE 115-a may receive an indication (e.g., via an RRC configuration or SIB configuration) of the search space periodicity. Additionally, or alternatively, the UE 115-a may drop candidate control signals (e.g., opposed to entire search spaces) while operating in accordance with the low duty-cycle communication interval.

FIG. 3 shows an example of a signaling diagram 300 that supports scheduling and search spaces for low duty cycle NTNs in accordance with one or more aspects of the present disclosure. The signaling diagram 300 may implement, or be implemented by, aspects of the wireless communications systems 100 and 200, as described with reference to FIGS. 1 and 2. For example, the signaling diagram 300 includes communication intervals 305 that each include one or more DL frames (e.g., a downlink communication sub-interval of a respective communication interval 305) with one or more DL subframes and one or more UL frames (e.g., an uplink communication sub-interval of a respective communication interval 305) with one or more UL subframes. The one or more DL frames and the one or more UL frames may be non-overlapping in accordance with an offset 310 (e.g., an offset in frames or subframes between an UL frame and a DL frame in a communication interval 305). While not illustrated for discussion purposes, it may be understood that there may be at least one invalid frame (e.g., an invalid sub-interval) including one or more invalid subframes between an UL frame of a first communication interval 305-a and an UL frame of a second communication interval 305-b. Additionally, or alternatively, there may be at least one invalid frame or invalid subframe between a DL frame of the first communication interval 305-a and a DL frame of the second communication interval 305-b.

In the signaling diagram 300, a UE (such as the UE 115-a described with reference to FIG. 2) may receive one or more downlink transmissions in one or more DL frames, transmit one or more uplink transmissions in one or more UL frames (e.g., in one or more UL subframes), or both, across the communication intervals 305. For example, the UE 115-a may receive a PDCCH message 320 during a DL frame in the first communication interval 305-a, the second communication interval 305-b, or both.

In some examples, the UE 115-a may receive a first PDCCH message 320-a during the first communication interval 305-a. The first PDCCH message 320-a may schedule (e.g., via DCI) one or more PUSCH messages 325. For example, the first PDCCH message 320-a may schedule four repetitions of a PUSCH message 325. In some cases, the first PDCCH message 320-a may include a first scheduling delay value 315-a indicating the UE to transmit the one or more PUSCH messages 325 beginning at an eighth subframe of the one or more UL frames in the first communication interval 305-a (e.g., the first scheduling delay value may indicate a quantity of subframes between the tenth subframe of the first DL frame and the eighth subframe of the first UL frame). The UE may transmit a first subset of the scheduled PUSCH messages 325-a during the first communication interval 305-a and a second subset of the scheduled PUSCH messages (e.g., the remaining PUSCH repetition) during the second communication interval 305-b because the subframe after the last UL subframe may be an invalid subframe. That is, the UE may postpone transmitting the second subset until a next valid UL subframe (e.g., based on a quantity of the PUSCH messages 325 exceeding a remaining quantity of UL subframes in the first communication interval 305-a).

Additionally, or alternatively, the UE 115-a may receive a second PDCCH message 320-b during the second communication interval 305-b. In some cases, the second PDCCH message 320-b may schedule one or more PUSCH messages 325-b via a second scheduling delay value 315-b. In other wireless communication systems, a UE may receive a scheduling delay value 315-b that results in a collision between the PUSCH messages 325 scheduled by the first PDCCH message 320-a and the PUSCH messages 325 scheduled by the second PDCCH message 320-b. For example, other wireless communication systems may select a scheduling delay value 315 from a relatively limited set of scheduling delay values (e.g., 8, 16, 32, 64). In the other wireless communications systems, a second scheduling delay value 315-b of 32 subframes may result in a collision at the subframe 330 (e.g., the second subset of PUSCH messages 325 and the one or more PUSCH messages 325-b may be scheduled in overlapping subframes), while a next supported scheduling delay value (e.g., 64) may result in scheduling the one or more PUSCH messages 325-b in one or more invalid subframes (e.g., resulting in postponement of the PUSCH messages). That is, the scheduling delay values in other wireless communications systems may result in transmission collisions based on a misalignment between the scheduling delay values and the communication intervals 305.

The techniques described herein support the UE to receive scheduling delay values 315 that may be aligned with the communication intervals 305 (e.g., aligned with the valid UL/DL frames). In some examples, the scheduling delay values 315 may be shifted by integer multiples of the communication interval 305. For example, a scheduling delay value may be equal to k₀+Q×t, where Q is a quantity of duty-cycle shifts (e.g., shifts in a quantity of communication intervals 305), such as Q∈{1,2,3,4}, and t is a duration of a respective communication interval 305.

In some examples, the UE may receive DCI that indicates the scheduling delay value 315 (e.g., indicates Q). In some examples, the DCI may indicate the scheduling delay value 315 via a bitfield in the DCI (e.g., a 2 bitfield to indicate 4 shifts of the communication interval 305). For example, the bit field may indicate 0, 1, 2 or 3 intervals of scheduling delay (e.g., 0, 1, 2, or 3 communication intervals 305). The UE may use the indication in conjunction with a previous scheduling delay value (e.g., associated with non-low duty-cycle communication frameworks) to determine the scheduling delay value 315. In some cases, the bitfield to indicate the scheduling delay value 315 may be added to the DCI. In some other cases, the DCI may re-use other bits to indicate the scheduling delay value 315 (e.g., the DCI may drop less relevant bits in accordance with a first format for low duty-cycle communication frameworks). For example, the DCI may reduce a bitfield for indicating a quantity of uplink transmission repetitions from four bits to three bits, and the DCI may use the fourth bit to indicate the scheduling delay value 315 (e.g., low duty-cycle communication intervals may not use larger repetition quantities such as 1024 in some examples). In such other cases, the UE may parse (e.g., interpret or decode) the DCI differently than DCI in accordance with a second format for non-low duty-cycle communication frameworks (e.g., based on communicating in accordance with the low duty-cycle communication framework).

Additionally, or alternatively, the scheduling delay value 315 may be based on a quantity of valid subframes (e.g., UL and/or DL subframes) in a communication interval 305. For example, for a second scheduling delay value 315-b of 32 subframes, the UE may begin counting at the first valid UL subframe 330 rather than at the ninth subframe of the DL frame in the second communication interval 305-b. That is, the UE may determine the scheduling delay value 315 based on not counting the invalid subframes in the communication intervals 305. In some examples, an indicated scheduling delay value 315 (e.g., based on a quantity of valid subframes) may be different than an absolute scheduling delay value 315 (e.g., based on a quantity of valid and invalid subframes). For example, the UE may receive an indicated scheduling delay value 315 that is 32 subframes (e.g., or milliseconds). Based on counting 32 valid subframes, the absolute scheduling delay value 315 may be different (e.g., larger) than the indicated scheduling delay value 315. For example, the absolute scheduling delay value 315 may include the 32 valid subframes and one or more invalid subframes (e.g., that are between valid subframes). That is, the absolute scheduling delay value 315 may be different based on the UE not counting the invalid subframes as part of the indicated scheduling delay value 315.

In either example (e.g., indicating integer multiple shifts or counting valid subframes), a quantity of available scheduling delay values 315 for low duty-cycle communication intervals may be increased relative to non-low duty-cycle communication intervals. For example, a quantity of scheduling delay values 315 for scheduling physical downlink shared channel (PDSCH) messages, for HARQ-ACK messages, and for message 3 (e.g., for a random access procedure) may be increased to include scheduling delay values 315 that align with a communication interval (e.g., increased from a set of {0, . . . 128} for PDSCH, from a set of {13, 15, 17, 18} for HARQ-ACK, and/or from a set of {12,16,32,64} for Msg3). In some examples, a quantity of available scheduling delay values 315 may be based on the type of transmission (e.g., PUSCH, PDSCH, HARQ-ACK, or Msg3).

Additionally, or alternatively, the techniques described herein may support the UE to receive search space periodicities that may be aligned with the communication intervals 305. As described further with reference to FIG. 2, the UE may receive control signaling, such as the first PDCCH message 320-a and/or the second PDCCH message 320-b, based on monitoring one or more search spaces that each include one or more search space candidates in accordance with a search space periodicity. The search space periodicity may be shifted by integer multiples of the duty-cycle communication interval 305. In some examples, the UE may receive an indication (e.g., a direct or explicit indication) of the search space periodicity via RRC configuration signaling, SIB configuration signaling, or both. Additionally, or alternatively, a set of values (e.g., G) that indicate the search space periodicity may be increased to include periodicities that align with the communication intervals 305. That is, for search space periodicities based on G×Rₘₐₓ(≥4), G may be based on the communication intervals 305.

In some other wireless communications systems, a UE may drop a first search space (e.g., when the UE is not configured with twoHARQ-ProcessesConfig) if a first search space candidate, such as a PDCCH candidate, of the first search space ends in a subframe n and if the UE monitors second search space candidates of a second search space having a starting subframe k₀ before subframe n+5. That is, the UE may drop the first search space based on a duration between the first search space candidate and the second search space candidates being less than a threshold duration (e.g., n+5). The techniques described herein enable the UE to drop the first search space candidate (e.g., opposed to the first search space) based on the duration between the first search space candidate and the second search space candidates being less than the threshold duration (e.g., irrespective of a quantity of HARQ processes supported or configured).

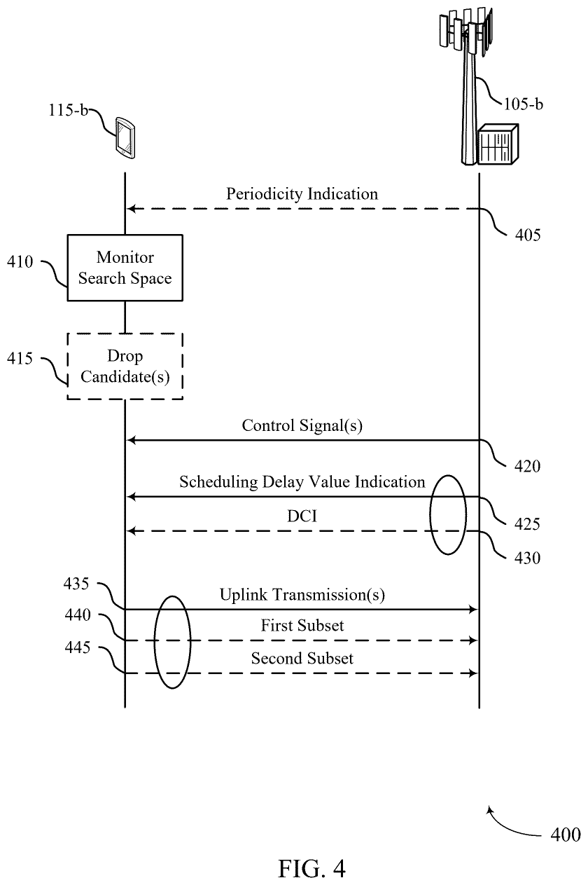

FIG. 4 shows an example of a process flow 400 that supports scheduling and search spaces for low duty cycle NTNs in accordance with one or more aspects of the present disclosure. The process flow 400 may implement or be implemented by aspects of any of the wireless communications system or signaling diagram described with reference to FIGS. 1 through 3. For example, the process flow 400 includes a network entity 105-b and a UE 115-b, which may be examples of corresponding devices described herein, including with reference to FIGS. 1 and 2. In the following description of the process flow 400, operations between the network entity 105-b and the UE 115-b may be added, omitted, or performed in a different order (with respect to the exemplary order shown).

At 405, the UE 115-b may receive an indication of a periodicity associated with a search space. In some examples, the UE 115-b may receive RRC signaling, system information signaling (e.g., SIB), or any combination thereof, that includes the indication. In some examples, the periodicity may be based on one or more communication intervals (e.g., one or more communication intervals 305). Each of the one or more communication intervals may include: one or more UL communication frames (e.g., an uplink communication sub-interval) including one or more UL communication subframes, one or more DL communication frames (e.g., a downlink communication sub-interval) including one or more DL communication subframes, where one or more UL communication frames is non-overlapping in time with the one or more DL communication frames, and multiple invalid frames (e.g., an invalid sub-interval) each including one or more invalid subframes. In some examples, at least one invalid subframe (e.g., of the invalid sub-interval) may be between the UL communication sub-interval and a next UL communication sub-interval of a next communication interval. Additionally, or alternatively, each communication interval may further include at least one invalid subframe (e.g., of the invalid sub-interval) between the DL communication sub-interval and a next DL communication sub-interval of the next communication interval.

In some examples, the periodicity may be based on a quantity of one or more UL communication subframes included in the one or more communications intervals, a quantity of one or more DL communication frames included in the one or more communications intervals, or both. Additionally, or alternatively, the periodicity may be based on a quantity of communication intervals from among the one or more communication intervals, a duration of a communication interval from among the one or more communication intervals (e.g., based on a duration of the low duty-cycle), or both.

At 410, the UE 115-b may monitor a search space including multiple control signal candidates (e.g., PDCCH candidates) in accordance with periodicity. For example, the UE 115-b may monitor the search space in accordance with the periodicity based on the indication (e.g., receiving the indication of the periodicity). At 415, the UE 115-b may drop one or more second control signal candidates from among the multiple control signal candidates based on a time duration between the one or more control signal candidates and a control signal candidate from a second search space (e.g., the second search space different from the search space) being less than a threshold duration, as described with reference to FIG. 3. For example, the UE 115-b may drop a second control signal candidate based on a collision with a first control signal candidate. In some examples, the UE 115-b may drop the one or more control signal candidates irrespective of a quantity of HARQ processes supported.

At 420, the UE 115-b may receive one or more control signals associated with the one or more control signal candidates of the multiple control signal candidates based on monitoring the search space in accordance with the periodicity.

At 425, the UE 115-b may receive an indication of a scheduling delay value for one or more transmissions. For example, the UE 115-b may receive the indication of the scheduling delay value based on receiving the one or more control signals (e.g., the one or more control signals may include the indication of the scheduling delay value). In some examples, the scheduling delay value may be based on the transmissions being in accordance with the one or more communication intervals. In some other examples, the scheduling delay value may be based on a quantity of communication intervals from among the one or more communication intervals and may further be based on a duration of a communication interval from among the one or more communications intervals (e.g., based on a duration of the low duty-cycle). Additionally, or alternatively, the scheduling delay value may be based on a quantity of one or more UL communication subframes included in the one or more communication intervals, a quantity of one or more DL communication subframes included in the one or more communication intervals, or both (e.g., based on valid frames in the communication intervals). In some cases, the scheduling delay value may be independent of a quantity of invalid subframes included in the one or more communication intervals (e.g., the UE 115-b may determine the scheduling delay value based on not counting the invalid subframes).

In some examples, at 430, receiving the indication may include receiving DCI indicating a quantity of communication intervals from among the one or more communication intervals, where the scheduling delay value may be based on the quantity of communication intervals from among the one or more communication intervals. In some examples, the DCI may be in accordance with a first format associated with the one or more communication intervals and may indicate the quantity of communication intervals via a first portion of the DCI.

At 435, the UE 115-b may transmit, via one or more UL communication subframes or one or more DL communication subframes included in the one or more communication intervals, the one or more transmissions in accordance with the scheduling delay value. In some examples, the one or more transmissions may include one or more PUSCH transmissions, one or more PDSCH transmissions, one or more random access messages (e.g., a Msg3), one or more feedback response messages (e.g., HARQ-ACK), or any combination thereof. In some examples, at 440, transmitting the one or more transmissions in accordance with the scheduling delay value may include transmitting a first subset of the one or more transmissions in a first set of one or more UL communication subframes or one or more DL communication subframes included in a first communication interval included in the one or more communication intervals. At 445, the UE 115-b may transmit, in accordance with the scheduling delay value, a second subset of the one or more transmissions in a second set of one or more UL communication subframes or one or more DL communication subframes included in a second communication interval included in the one or more communication intervals.

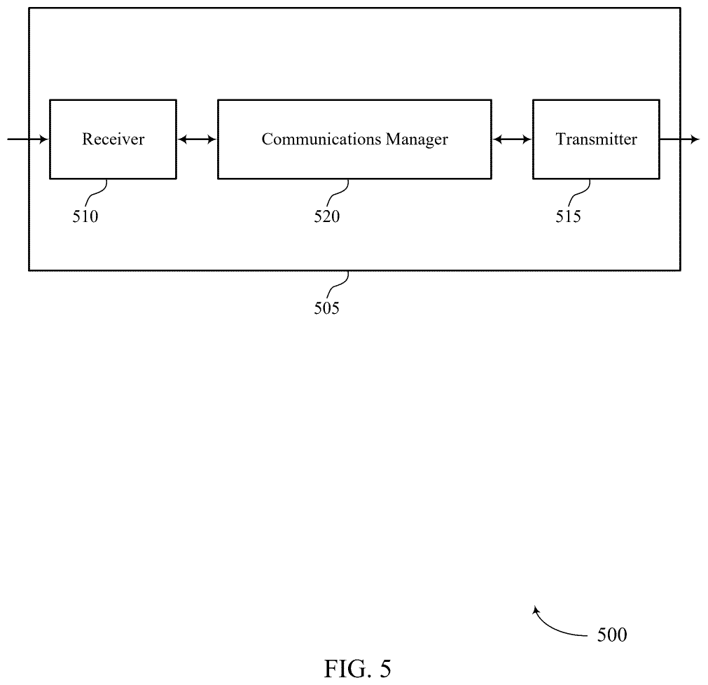

FIG. 5 shows a block diagram 500 of a device 505 that supports scheduling and search spaces for low duty cycle NTNs in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to scheduling and search spaces for low duty cycle NTNs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to scheduling and search spaces for low duty cycle NTNs). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of scheduling and search spaces for low duty cycle NTNs as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving an indication of a scheduling delay value for one or more transmissions, where the scheduling delay value is based on the one or more transmissions being in accordance with one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the uplink communication sub-interval and a next uplink communication sub-interval of a next communication interval, and where at least one invalid subframe of the invalid sub-interval is between the downlink communication sub-interval and a next downlink communication sub-interval of the next communication interval. The communications manager 520 is capable of, configured to, or operable to support a means for transmitting, or receiving, via one or more uplink communication subframes or one or more downlink communication subframes included in the one or more communication intervals, the one or more transmissions in accordance with the scheduling delay value.

Additionally, or alternatively, the communications manager 520 may support wireless communications in accordance with examples as disclosed herein. For example, the communications manager 520 is capable of, configured to, or operable to support a means for monitoring a search space including a set of multiple control signal candidates in accordance with a periodicity, where the periodicity is based on one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the downlink communication sub-interval and a next downlink communication sub-interval of a next communication interval, and where at least one invalid subframe of the invalid sub-interval is between the uplink communication sub-interval and a next uplink communication sub-interval of a next communication interval. The communications manager 520 is capable of, configured to, or operable to support a means for receiving one or more control signals associated with one or more control signal candidates of the set of multiple control signal candidates based on monitoring the search space in accordance with the periodicity.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption and more efficient utilization of communication resources, among other examples.

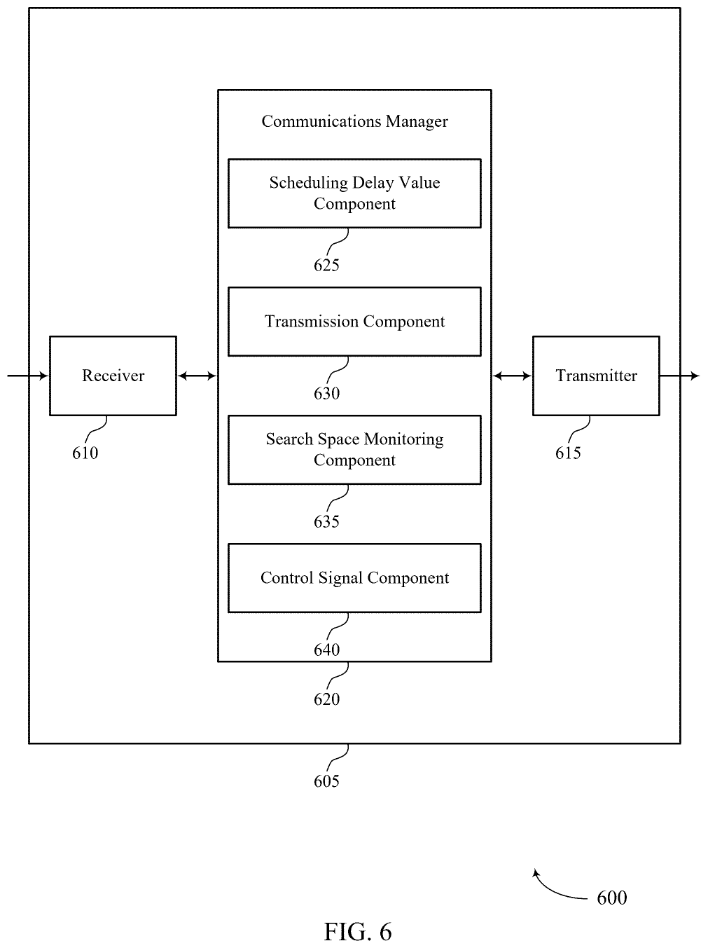

FIG. 6 shows a block diagram 600 of a device 605 that supports scheduling and search spaces for low duty cycle NTNs in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to scheduling and search spaces for low duty cycle NTNs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to scheduling and search spaces for low duty cycle NTNs). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of scheduling and search spaces for low duty cycle NTNs as described herein. For example, the communications manager 620 may include a scheduling delay value component 625, a transmission component 630, a search space monitoring component 635, a control signal component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The scheduling delay value component 625 is capable of, configured to, or operable to support a means for receiving an indication of a scheduling delay value for one or more transmissions, where the scheduling delay value is based on the one or more transmissions being in accordance with one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the uplink communication sub-interval and a next uplink communication sub-interval of a next communication interval, and where at least one invalid subframe of the invalid sub-interval is between the downlink communication sub-interval and a next downlink communication sub-interval of the next communication interval. The transmission component 630 is capable of, configured to, or operable to support a means for transmitting, or receiving, via one or more uplink communication subframes or one or more downlink communication subframes included in the one or more communication intervals, the one or more transmissions in accordance with the scheduling delay value.

Additionally, or alternatively, the communications manager 620 may support wireless communications in accordance with examples as disclosed herein. The search space monitoring component 635 is capable of, configured to, or operable to support a means for monitoring a search space including a set of multiple control signal candidates in accordance with a periodicity, where the periodicity is based on one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the downlink communication sub-interval and a next downlink communication sub-interval of a next communication interval, and where at least one invalid subframe of the invalid sub-interval is between the uplink communication sub-interval and a next uplink communication sub-interval of a next communication interval. The control signal component 640 is capable of, configured to, or operable to support a means for receiving one or more control signals associated with one or more control signal candidates of the set of multiple control signal candidates based on monitoring the search space in accordance with the periodicity.

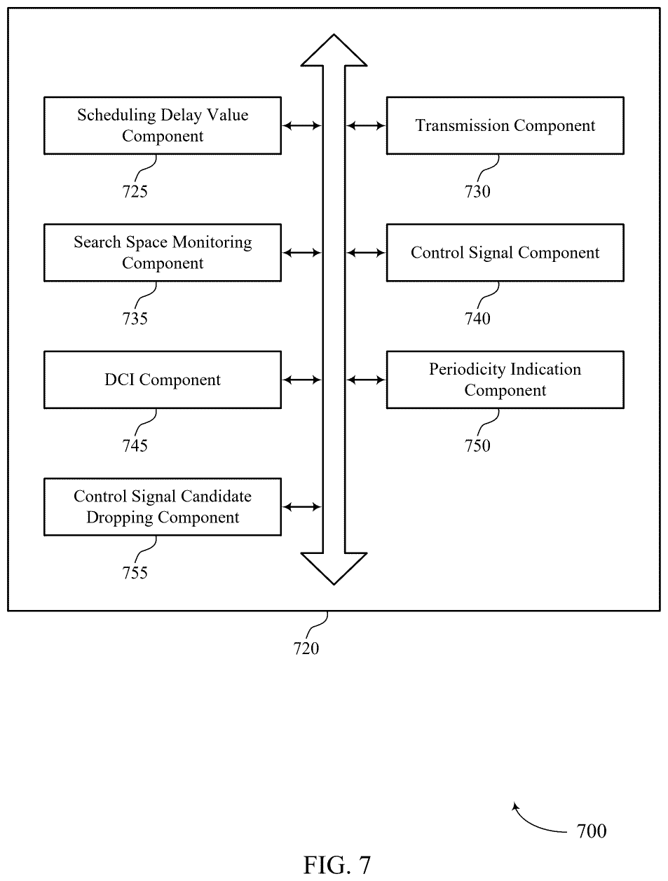

FIG. 7 shows a block diagram 700 of a communications manager 720 that supports scheduling and search spaces for low duty cycle NTNs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of scheduling and search spaces for low duty cycle NTNs as described herein. For example, the communications manager 720 may include a scheduling delay value component 725, a transmission component 730, a search space monitoring component 735, a control signal component 740, a DCI component 745, a periodicity indication component 750, a control signal candidate dropping component 755, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The scheduling delay value component 725 is capable of, configured to, or operable to support a means for receiving an indication of a scheduling delay value for one or more transmissions, where the scheduling delay value is based on the one or more transmissions being in accordance with one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the uplink communication sub-interval and a next uplink communication sub-interval of a next communication interval, and where at least one invalid subframe of the invalid sub-interval is between the downlink communication sub-interval and a next downlink communication sub-interval of the next communication interval. The transmission component 730 is capable of, configured to, or operable to support a means for transmitting, or receiving, via one or more uplink communication subframes or one or more downlink communication subframes included in the one or more communication intervals, the one or more transmissions in accordance with the scheduling delay value.

In some examples, to support transmitting, or receiving, the one or more transmissions in accordance with the scheduling delay value, the transmission component 730 is capable of, configured to, or operable to support a means for transmitting, or receiving, a first subset of the one or more transmissions in a first set of one or more uplink communication subframes or one or more downlink communication subframes included in a first communication interval included in the one or more communication intervals. In some examples, to support transmitting, or receiving, the one or more transmissions in accordance with the scheduling delay value, the transmission component 730 is capable of, configured to, or operable to support a means for transmitting, or receiving, in accordance with the scheduling delay value, a second subset of the one or more transmissions in a second set of one or more uplink communication subframes or one or more downlink communication subframes included in a second communication interval included in the one or more communication intervals.

In some examples, to support receiving the indication, the DCI component 745 is capable of, configured to, or operable to support a means for receiving DCI indicating a quantity of communication intervals from among the one or more communication intervals, where the scheduling delay value is based on the quantity of communication intervals from among the one or more communication intervals. In some examples, the DCI is in accordance with a first format associated with the one or more communication intervals and indicates the quantity of communication intervals via a first portion of the DCI.

In some examples, the scheduling delay value is based on at least one of: a quantity of communication intervals included in the one or more communication intervals or a duration of a communication interval from among the one or more communication intervals. In some examples, the scheduling delay value is based on a quantity of one or more uplink communication subframes included in the one or more communication intervals, a quantity of one or more downlink communication subframes included in the one or more communication intervals, or both. In some examples, the scheduling delay value is independent of a quantity of invalid subframes included in the one or more communication intervals.

In some examples, the one or more uplink transmissions include one or more PUSCH transmissions, one or more PDSCH transmissions, one or more random access messages, one or more feedback response messages, or any combination thereof.

Additionally, or alternatively, the communications manager 720 may support wireless communications in accordance with examples as disclosed herein. The search space monitoring component 735 is capable of, configured to, or operable to support a means for monitoring a search space including a set of multiple control signal candidates in accordance with a periodicity, where the periodicity is based on one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the downlink communication sub-interval and a next downlink communication sub-interval of a next communication interval, and where at least one invalid subframe of the invalid sub-interval is between the uplink communication sub-interval and a next uplink communication sub-interval of a next communication interval. The control signal component 740 is capable of, configured to, or operable to support a means for receiving one or more control signals associated with one or more control signal candidates of the set of multiple control signal candidates based on monitoring the search space in accordance with the periodicity.

In some examples, the periodicity indication component 750 is capable of, configured to, or operable to support a means for receiving an indication of the periodicity, where monitoring the search space in accordance with the periodicity is based on the indication. In some examples, to support receiving the indication, the periodicity indication component 750 is capable of, configured to, or operable to support a means for receiving RRC signaling, system information signaling, or any combination thereof that includes the indication.

In some examples, the control signal candidate dropping component 755 is capable of, configured to, or operable to support a means for dropping one or more second control signal candidates from among the set of multiple control signal candidates based on a time duration between the one or more second control signal candidates and a control signal candidate from a second search space different from the search space being less than a threshold duration.

In some examples, the periodicity is based on at least one of: a quantity of communication intervals from among the one or more communication intervals or a duration of a communication interval from among the one or more communication intervals. In some examples, the periodicity is based on a quantity of one or more uplink communication subframes included in the one or more communication intervals, a quantity of one or more downlink communication subframes included in the one or more communication intervals, or both.

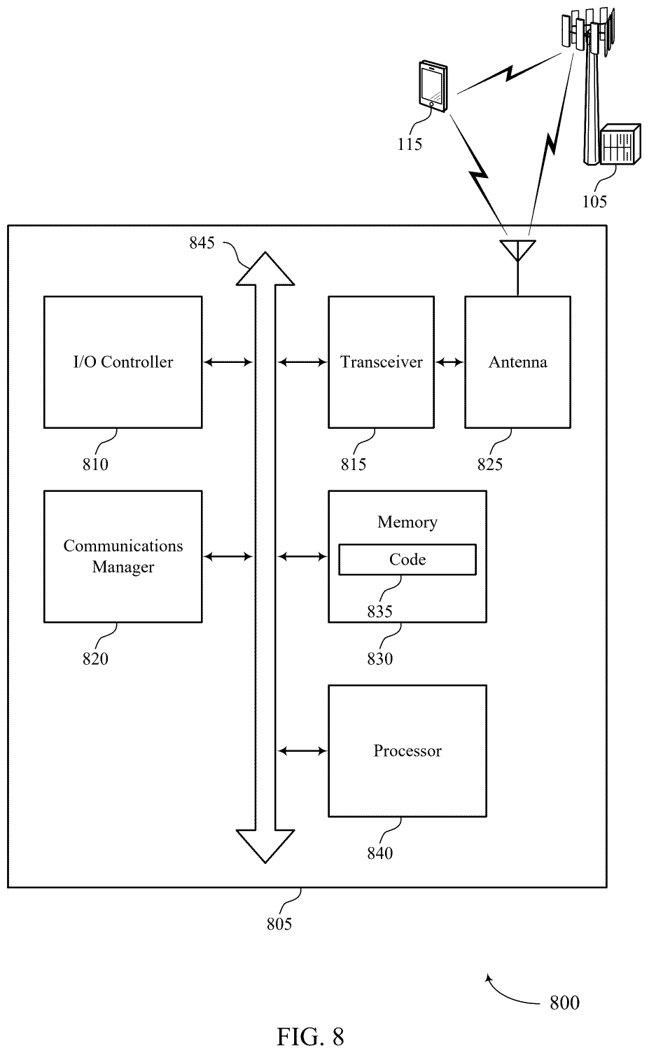

FIG. 8 shows a diagram of a system 800 including a device 805 that supports scheduling and search spaces for low duty cycle NTNs in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting scheduling and search spaces for low duty cycle NTNs). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving an indication of a scheduling delay value for one or more transmissions, where the scheduling delay value is based on the one or more transmissions being in accordance with one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the uplink communication sub-interval and a next uplink communication sub-interval of a next communication interval, and where at least one invalid subframe of the invalid sub-interval is between the downlink communication sub-interval and a next downlink communication sub-interval of the next communication interval. The communications manager 820 is capable of, configured to, or operable to support a means for transmitting, or receiving, via one or more uplink communication subframes or one or more downlink communication subframes included in the one or more communication intervals, the one or more transmissions in accordance with the scheduling delay value.

Additionally, or alternatively, the communications manager 820 may support wireless communications in accordance with examples as disclosed herein. For example, the communications manager 820 is capable of, configured to, or operable to support a means for monitoring a search space including a set of multiple control signal candidates in accordance with a periodicity, where the periodicity is based on one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the downlink communication sub-interval and a next downlink communication sub-interval of a next communication interval, and where at least one invalid subframe of the invalid sub-interval is between the uplink communication sub-interval and a next uplink communication sub-interval of a next communication interval. The communications manager 820 is capable of, configured to, or operable to support a means for receiving one or more control signals associated with one or more control signal candidates of the set of multiple control signal candidates based on monitoring the search space in accordance with the periodicity.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, and longer battery life, among other examples.

In some examples, the communications manager 820 may be configured to perform various operations (e.g., receiving, monitoring, transmitting) using or otherwise in cooperation with the transceiver 815, the one or more antennas 825, or any combination thereof. For example, the communications manager 820 may be configured to receive or transmit messages or other signaling as described herein via the transceiver 815. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of scheduling and search spaces for low duty cycle NTNs as described herein, or the at least one processor 840 and the at least one memory 830 may be otherwise configured to, individually or collectively, perform or support such operations.

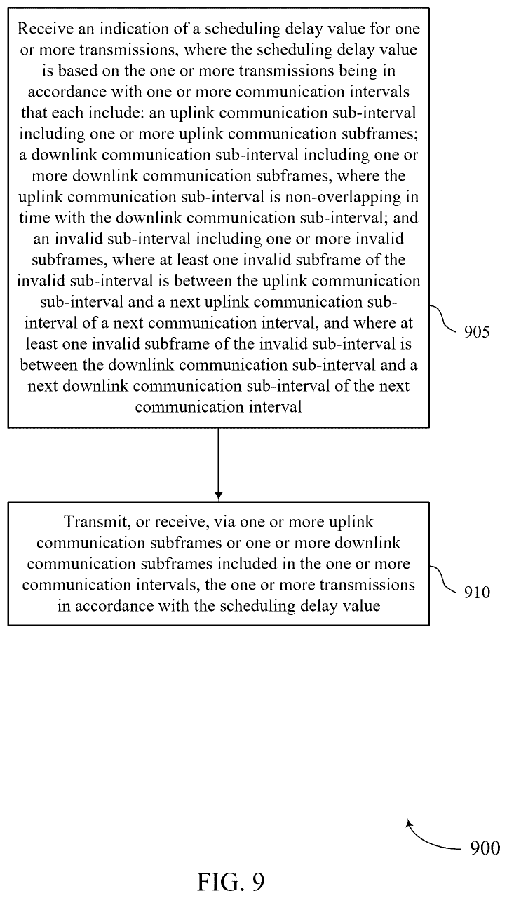

FIG. 9 shows a flowchart illustrating a method 900 that supports scheduling and search spaces for low duty cycle NTNs in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving an indication of a scheduling delay value for one or more transmissions, where the scheduling delay value is based on the one or more transmissions being in accordance with one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the uplink communication sub-interval and a next uplink communication sub-interval of a next communication interval, and where at least one invalid subframe of the invalid sub-interval is between the downlink communication sub-interval and a next downlink communication sub-interval of the next communication interval. The operations of 905 may be performed in accordance with examples as disclosed herein. In some examples, aspects of the operations of 905 may be performed by a scheduling delay value component 725 as described with reference to FIG. 7. Additionally, or alternatively, means for performing 905 may, but not necessarily include, for example, one or more antennas 825, transceiver 815, communications manager 820, at least one memory 830 (including code 835), at least one processor 840 and/or bus 845.

At 910, the method may include transmitting, or receiving, via one or more uplink communication subframes or one or more downlink communication subframes included in the one or more communication intervals, the one or more transmissions in accordance with the scheduling delay value. The operations of 910 may be performed in accordance with examples as disclosed herein. In some examples, aspects of the operations of 910 may be performed by a transmission component 730 as described with reference to FIG. 7. Additionally, or alternatively, means for performing 910 may, but not necessarily include, for example, one or more antennas 825, transceiver 815, communications manager 820, at least one memory 830 (including code 835), at least one processor 840 and/or bus 845.

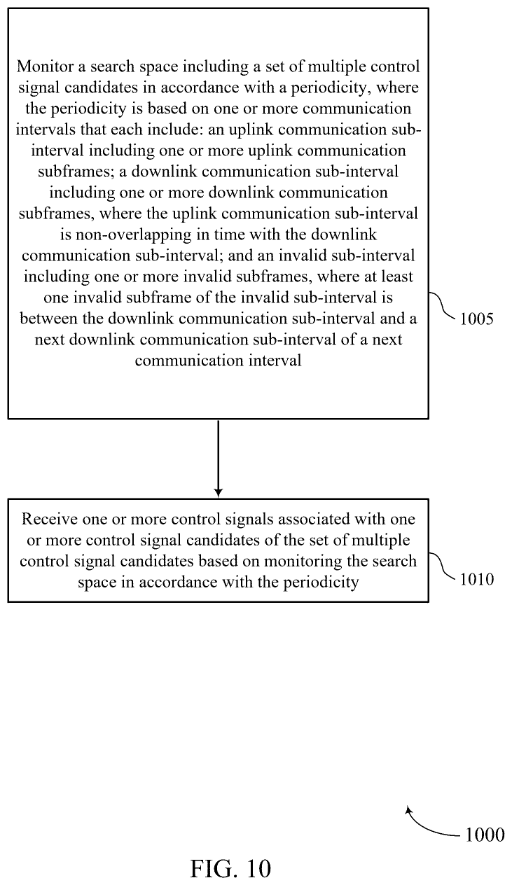

FIG. 10 shows a flowchart illustrating a method 1000 that supports scheduling and search spaces for low duty cycle NTNs in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include monitoring a search space including a set of multiple control signal candidates in accordance with a periodicity, where the periodicity is based on one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the downlink communication sub-interval and a next downlink communication sub-interval of a next communication interval, and where at least one invalid subframe of the invalid sub-interval is between the uplink communication sub-interval and a next uplink communication sub-interval of a next communication interval. The operations of 1005 may be performed in accordance with examples as disclosed herein. In some examples, aspects of the operations of 1005 may be performed by a search space monitoring component 735 as described with reference to FIG. 7. Additionally, or alternatively, means for performing 1005 may, but not necessarily include, for example, one or more antennas 825, transceiver 815, communications manager 820, at least one memory 830 (including code 835), at least one processor 840 and/or bus 845.

At 1010, the method may include receiving one or more control signals associated with one or more control signal candidates of the set of multiple control signal candidates based on monitoring the search space in accordance with the periodicity. The operations of 1010 may be performed in accordance with examples as disclosed herein. In some examples, aspects of the operations of 1010 may be performed by a control signal component 740 as described with reference to FIG. 7. Additionally, or alternatively, means for performing 1010 may, but not necessarily include, for example, one or more antennas 825, transceiver 815, communications manager 820, at least one memory 830 (including code 835), at least one processor 840 and/or bus 845.

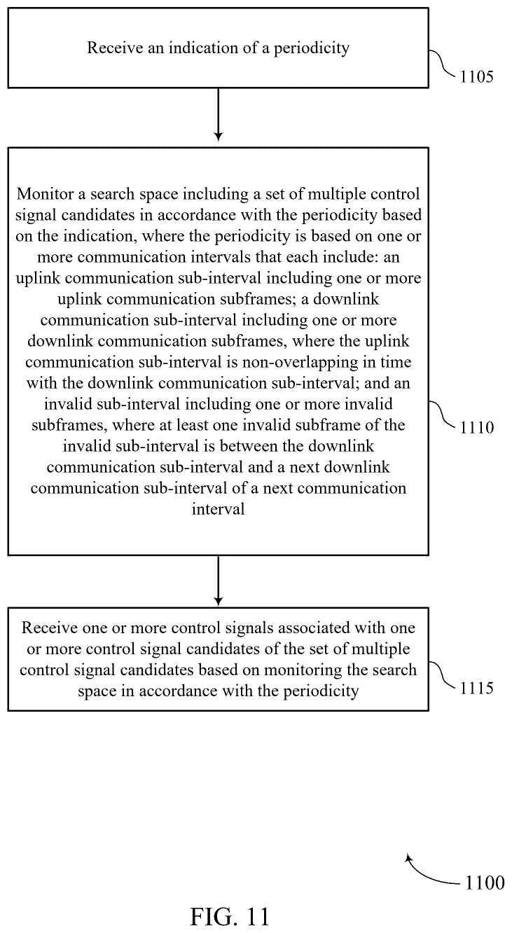

FIG. 11 shows a flowchart illustrating a method 1100 that supports scheduling and search spaces for low duty cycle NTNs in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving an indication of a periodicity.

The operations of 1105 may be performed in accordance with examples as disclosed herein. In some examples, aspects of the operations of 1105 may be performed by a periodicity indication component 750 as described with reference to FIG. 7.

Additionally, or alternatively, means for performing 1105 may, but not necessarily include, for example, one or more antennas 825, transceiver 815, communications manager 820, at least one memory 830 (including code 835), at least one processor 840 and/or bus 845.

At 1110, the method may include monitoring a search space including a set of multiple control signal candidates in accordance with the periodicity based at least in part on the indication of the periodicity, where the periodicity is based on one or more communication intervals that each include: an uplink communication sub-interval including one or more uplink communication subframes; a downlink communication sub-interval including one or more downlink communication subframes, where the uplink communication sub-interval is non-overlapping in time with the downlink communication sub-interval; and an invalid sub-interval including one or more invalid subframes, where at least one invalid subframe of the invalid sub-interval is between the downlink communication sub-interval and a next downlink communication sub-interval of a next communication interval, and where at least one invalid subframe of the invalid sub-interval is between the uplink communication sub-interval and a next uplink communication sub-interval of a next communication interval. The operations of 1110 may be performed in accordance with examples as disclosed herein. In some examples, aspects of the operations of 1110 may be performed by a search space monitoring component 735 as described with reference to FIG. 7. Additionally, or alternatively, means for performing 1110 may, but not necessarily include, for example, one or more antennas 825, transceiver 815, communications manager 820, at least one memory 830 (including code 835), at least one processor 840 and/or bus 845.

At 1115, the method may include receiving one or more control signals associated with one or more control signal candidates of the set of multiple control signal candidates based on monitoring the search space in accordance with the periodicity. The operations of 1115 may be performed in accordance with examples as disclosed herein. In some examples, aspects of the operations of 1115 may be performed by a control signal component 740 as described with reference to FIG. 7.

Additionally, or alternatively, means for performing 1115 may, but not necessarily include, for example, one or more antennas 825, transceiver 815, communications manager 820, at least one memory 830 (including code 835), at least one processor 840 and/or bus 845.

The following provides an overview of aspects of the present disclosure:

Aspect 1: A method for wireless communications by a UE, comprising: receiving an indication of a scheduling delay value for one or more transmissions, wherein the scheduling delay value is based at least in part on the one or more transmissions being in accordance with one or more communication intervals that each comprise: an uplink communication sub-interval comprising one or more uplink communication subframes; a downlink communication sub-interval comprising one or more downlink communication subframes, wherein the uplink communication sub-interval is non-overlapping in time with the downlink communication sub-interval; and an invalid sub-interval comprising one or more invalid subframes, wherein at least one invalid subframe of the invalid sub-interval is between the uplink communication sub-interval and a next uplink communication sub-interval of a next communication interval, and wherein at least one invalid subframe of the invalid sub-interval is between the downlink communication sub-interval and a next downlink communication sub-interval of the next communication interval; and transmitting, or receiving, via one or more uplink communication subframes or one or more downlink communication subframes included in the one or more communication intervals, the one or more transmissions in accordance with the scheduling delay value.

Aspect 2: The method of aspect 1, wherein transmitting, or receiving, the one or more transmissions in accordance with the scheduling delay value comprises: transmitting, or receiving, a first subset of the one or more transmissions in a first set of one or more uplink communication subframes or one or more downlink communication subframes included in a first communication interval included in the one or more communication intervals; and transmitting, or receiving, in accordance with the scheduling delay value, a second subset of the one or more transmissions in a second set of one or more uplink communication subframes or one or more downlink communication subframes included in a second communication interval included in the one or more communication intervals.

Aspect 3: The method of any of aspects 1 through 2, wherein receiving the indication comprises: receiving DCI indicating a quantity of communication intervals from among the one or more communication intervals, wherein the scheduling delay value is based at least in part on the quantity of communication intervals from among the one or more communication intervals.

Aspect 4: The method of aspect 3, wherein the DCI is in accordance with a first format associated with the one or more communication intervals and indicates the quantity of communication intervals via a first portion of the DCI.

Aspect 5: The method of any of aspects 1 through 4, wherein the scheduling delay value is based at least in part on at least one of: a quantity of communication intervals from among the one or more communication intervals or a duration of a communication interval from among the one or more communication intervals.

Aspect 6: The method of any of aspects 1 through 5, wherein the scheduling delay value is based at least in part on a quantity of one or more uplink communication subframes included in the one or more communication intervals, a quantity of one or more downlink communication subframes included in the one or more communication intervals, or both.

Aspect 7: The method of any of aspects 1 through 6, wherein the scheduling delay value is independent of a quantity of invalid subframes included in the one or more communication intervals.

Aspect 8: The method of any of aspects 1 through 7, wherein the one or more transmissions comprise one or more PUSCH transmissions, one or more PDSCH transmissions, one or more random access messages, one or more feedback response messages, or any combination thereof.

Aspect 9: A method for wireless communications by a UE, comprising: monitoring a search space comprising a plurality of control signal candidates in accordance with a periodicity, wherein the periodicity is based at least in part on one or more communication intervals that each comprise: an uplink communication sub-interval comprising one or more uplink communication subframes; a downlink communication sub-interval comprising one or more downlink communication subframes, wherein the uplink communication sub-interval is non-overlapping in time with the downlink communication sub-interval; and an invalid sub-interval comprising one or more invalid subframes, wherein at least one invalid subframe of the invalid sub-interval is between the downlink communication sub-interval and a next downlink communication sub-interval of a next communication interval; and receiving one or more control signals associated with one or more control signal candidates of the plurality of control signal candidates based at least in part on monitoring the search space in accordance with the periodicity.

Aspect 10: The method of aspect 9, further comprising: receiving an indication of the periodicity, wherein monitoring the search space in accordance with the periodicity is based at least in part on the indication.

Aspect 11: The method of aspect 10, wherein receiving the indication comprises: receiving RRC signaling, system information signaling, or any combination thereof that comprises the indication.

Aspect 12: The method of any of aspects 9 through 11, further comprising: dropping one or more second control signal candidates from among the plurality of control signal candidates based at least in part on a time duration between the one or more second control signal candidates and a control signal candidate from a second search space different from the search space being less than a threshold duration.

Aspect 13: The method of any of aspects 9 through 12, wherein the periodicity is based at least in part on at least one of: a quantity of communication intervals from among the one or more communication intervals or a duration of a communication interval from among the one or more communication intervals.

Aspect 14: The method of any of aspects 9 through 13, wherein the periodicity is based at least in part on a quantity of one or more uplink communication subframes included in the one or more communication intervals, a quantity of one or more downlink communication subframes included in the one or more communication intervals, or both.

Aspect 15: A UE for wireless communications, comprising one or more memories storing processor-executable code, a transceiver, and one or more processors coupled with the one or more memories and the transceiver, the one or more processors individually or collectively operable to execute the code to cause the UE to perform a method of any of aspects 1 through 8.

Aspect 16: A UE for wireless communications, comprising at least one means for performing a method of any of aspects 1 through 8.

Aspect 17: A non-transitory computer-readable medium storing code for wireless communications, the code comprising instructions executable by one or more processors to perform a method of any of aspects 1 through 8.

Aspect 18: A UE for wireless communications, comprising one or more memories storing processor-executable code, and one or more processors coupled with the one or more memories and individually or collectively operable to execute the code to cause the UE to perform a method of any of aspects 9 through 14.

Aspect 19: A UE for wireless communications, comprising at least one means for performing a method of any of aspects 9 through 14.

Aspect 20: A non-transitory computer-readable medium storing code for wireless communications, the code comprising instructions executable by one or more processors to perform a method of any of aspects 9 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code;
a transceiver; and
one or more processors coupled with the one or more memories and the transceiver, the one or more processors individually or collectively operable to execute the code to cause the UE to:
receive, via the transceiver, an indication of a scheduling delay value for one or more transmissions, wherein the scheduling delay value is based at least in part on the one or more transmissions being in accordance with one or more communication intervals that each comprise:
an uplink communication sub-interval comprising one or more uplink communication subframes;
a downlink communication sub-interval comprising one or more downlink communication subframes, wherein the uplink communication sub-interval is non-overlapping in time with the downlink communication sub-interval; and
an invalid sub-interval comprising one or more invalid subframes, wherein at least one invalid subframe of the invalid sub-interval is between the uplink communication sub-interval and a next uplink communication sub-interval of a next communication interval, and wherein at least one invalid subframe of the invalid sub-interval is between the downlink communication sub-interval and a next downlink communication sub-interval of the next communication interval; and
transmit or receive, via the transceiver and one or more uplink communication subframes or one or more downlink communication subframes included in the one or more communication intervals, the one or more transmissions in accordance with the scheduling delay value.

2. The UE of claim 1, wherein, to transmit, or receive, the one or more transmissions in accordance with the scheduling delay value, the one or more processors are individually or collectively operable to execute the code to cause the UE to:
transmit, or receive, via the transceiver, a first subset of the one or more transmissions in a first set of one or more uplink communication subframes or one or more downlink communication subframes included in a first communication interval included in the one or more communication intervals; and
transmit, or receive, via the transceiver and in accordance with the scheduling delay value, a second subset of the one or more transmissions in a second set of one or more uplink communication subframes or one or more downlink communication subframes included in a second communication interval included in the one or more communication intervals.

3. The UE of claim 1, wherein, to receive the indication, the one or more processors are individually or collectively operable to execute the code to cause the UE to:
receive, via the transceiver, downlink control information indicating a quantity of communication intervals from among the one or more communication intervals, wherein the scheduling delay value is based at least in part on the quantity of communication intervals from among the one or more communication intervals.

4. The UE of claim 3, wherein the downlink control information is in accordance with a first format associated with the one or more communication intervals and indicates the quantity of communication intervals via a first portion of the downlink control information.

5. The UE of claim 1, wherein the scheduling delay value is based at least in part on at least one of: a quantity of communication intervals from among the one or more communication intervals or a duration of a communication interval from among the one or more communication intervals.

6. The UE of claim 1, wherein the scheduling delay value is based at least in part on a quantity of one or more uplink communication subframes included in the one or more communication intervals, a quantity of one or more downlink communication subframes included in the one or more communication intervals, or both.

7. The UE of claim 1, wherein the scheduling delay value is independent of a quantity of invalid subframes included in the one or more communication intervals.

8. The UE of claim 1, wherein the one or more transmissions comprise one or more physical uplink shared channel transmissions, one or more physical downlink shared channel transmissions, one or more random access messages, one or more feedback response messages, or any combination thereof.

9. A user equipment (UE), comprising:
one or more memories storing processor-executable code;
a transceiver; and
one or more processors coupled with the one or more memories and the transceiver, the one or more processors individually or collectively operable to execute the code to cause the UE to:
monitor a search space comprising a plurality of control signal candidates in accordance with a periodicity, wherein the periodicity is based at least in part on one or more communication intervals that each comprise:
an uplink communication sub-interval comprising one or more uplink communication subframes;
a downlink communication sub-interval comprising one or more downlink communication subframes, wherein the uplink communication sub-interval is non-overlapping in time with the downlink communication sub-interval; and
an invalid sub-interval comprising one or more invalid subframes, wherein at least one invalid subframe of the invalid sub-interval is between the downlink communication sub-interval and a next downlink communication sub-interval of a next communication interval; and
receive, via the transceiver, one or more control signals associated with one or more control signal candidates of the plurality of control signal candidates based at least in part on monitoring the search space in accordance with the periodicity.

10. The UE of claim 9, wherein the one or more processors are individually or collectively further operable to execute the code to cause the UE to:
receive, via the transceiver, an indication of the periodicity, wherein the one or more processors are individually or collectively operable to execute the code to cause the UE to monitor the search space in accordance with the periodicity based at least in part on the indication.

11. The UE of claim 10, wherein, to receive the indication, the one or more processors are individually or collectively operable to execute the code to cause the UE to:
receive, via the transceiver, radio resource control signaling, system information signaling, or any combination thereof that comprises the indication.

12. The UE of claim 9, wherein the one or more processors are individually or collectively further operable to execute the code to cause the UE to:
drop one or more second control signal candidates from among the plurality of control signal candidates based at least in part on a time duration between the one or more second control signal candidates and a control signal candidate from a second search space different from the search space being less than a threshold duration.

13. The UE of claim 9, wherein the periodicity is based at least in part on at least one of: a quantity of communication intervals from among the one or more communication intervals or a duration of a communication interval from among the one or more communication intervals.

14. The UE of claim 9, wherein the periodicity is based at least in part on a quantity of one or more uplink communication subframes included in the one or more communication intervals, a quantity of one or more downlink communication subframes included in the one or more communication intervals, or both.

15. A method for wireless communications by a user equipment (UE), comprising:
receiving an indication of a scheduling delay value for one or more transmissions, wherein the scheduling delay value is based at least in part on the one or more transmissions being in accordance with one or more communication intervals that each comprise:
an uplink communication sub-interval comprising one or more uplink communication subframes;
a downlink communication sub-interval comprising one or more downlink communication subframes, wherein the uplink communication sub-interval is non-overlapping in time with the downlink communication sub-interval; and
an invalid sub-interval comprising one or more invalid subframes, wherein at least one invalid subframe of the one or more invalid subframes is between the uplink communication sub-interval and a next uplink communication sub-interval of a next communication interval, and wherein at least one invalid subframe of the invalid sub-interval is between the downlink communication sub-interval and a next downlink communication sub-interval of the next communication interval; and
transmitting, or receiving, via one or more uplink communication subframes or one or more downlink communication subframes included in the one or more communication intervals, the one or more transmissions in accordance with the scheduling delay value.

16. The method of claim 15, wherein transmitting, or receiving, the one or more transmissions in accordance with the scheduling delay value comprises:
transmitting, or receiving, a first subset of the one or more transmissions in a first set of one or more uplink communication subframes or one or more downlink communication subframes included in a first communication interval included in the one or more communication intervals; and
transmitting, or receiving, in accordance with the scheduling delay value, a second subset of the one or more transmissions in a second set of one or more uplink communication subframes or one or more downlink communication subframes included in a second communication interval included in the one or more communication intervals.

17. The method of claim 15, wherein receiving the indication comprises:
receiving downlink control information indicating a quantity of communication intervals from among the one or more communication intervals, wherein the scheduling delay value is based at least in part on the quantity of communication intervals from among the one or more communication intervals.

18. The method of claim 15, wherein the scheduling delay value is based at least in part on at least one of: a quantity of communication intervals from among the one or more communication intervals or a duration of a communication interval from among the one or more communication intervals.

19. The method of claim 15, wherein the scheduling delay value is based at least in part on a quantity of one or more uplink communication subframes included in the one or more communication intervals, a quantity of one or more downlink communication subframes included in the one or more communication intervals, or both.

20. The method of claim 15, wherein the one or more transmissions comprise one or more physical uplink shared channel transmissions, one or more physical downlink shared channel transmissions, one or more random access messages, one or more feedback response messages, or any combination thereof.
